(19) United States
(12) Patent Application Publication
(10) Pub. No.: US 2017/0193646 A1
(43) Pub. Date: Jul. 6, 2017

(54) DUST DETECTION SYSTEM FOR A WORKSITE

(71) Applicant: Caterpillar Inc., Peoria, IL (US)

(72) Inventor: Qi Wang, Pittsburgh, PA (US)

(73) Assignee: Caterpillar Inc., Peoria, IL (US)

(21) Appl. No.: 14/987,899

(22) Filed: Jan. 5, 2016

(51) Int. Cl. G06T 7/00; B64C 39/02

(52) U.S. Cl. CPC G06T 7/001; B64C 39/024; G06T 2207/10032; B64C 2201/127

(57) ABSTRACT

A method of detecting dust at a worksite. The method comprises generating a reference aerial view of at least a portion of the worksite from a first aircraft equipped with a perception sensor and a position detector during a no-dust condition of the worksite. The method further comprises generating a current aerial view of at least the portion of the worksite from a second aircraft equipped with a perception sensor and a position detector. A controller is configured to determine the presence of dust at the portion of the worksite on finding a difference in vision data between the current aerial view and the reference aerial view.

### TECHNICAL FIELD

The present disclosure relates to a worksite. In particular, the present disclosure relates to a dust detection system for a worksite.

### BACKGROUND

Worksites associated with mining, excavation, construction, landfills, and material stockpiles may be particularly susceptible to dust due to the nature of the materials forming the worksite. Further, worksites may have coal, shale, stone, etc., disposed on its surface, which may erode and generate significant amount of dust. Moreover, typical work operations such as cutting, digging, and scraping also increases amount of dust at worksite. In addition, heavy machinery, such as haul trucks, dozers, loaders, excavators, etc., traveling on such sites may disturb settled dust, thereby increasing dust level in the air.

Undue dust conditions may reduce the efficiency machines working at a worksite. For example, dust may impair visibility, interfere with work operations on the site, and require increased equipment maintenance and cleaning. To control the dust conditions, effective dust detection systems are required.

Current dust detection mainly relies on human perception on the basis of which commands are given to fluid distribution systems. For example, instructions may be sent to a water truck for spraying water over the worksite.

CN Patent No. 104155994 discloses urban engineering environment monitoring method using an unmanned helicopter. The unmanned helicopter includes a dust detector and a remote sensing equipment. The dust concentration of the engineering site is detected via the dust detector. When the dust concentration exceeds a threshold value, the image data of the engineering site is recorded and monitored.

### SUMMARY OF THE INVENTION

In an aspect of the present disclosure, a method of detecting dust at a worksite is disclosed. The method includes generating a reference aerial view of at least a portion of the worksite from a first aircraft equipped with a perception sensor and a position detector during a no dust condition of the worksite, generating a current aerial view of at least the portion of the worksite from a second aircraft equipped with a perception sensor and a position detector and determining presence of dust at the portion of the worksite on finding a difference in vision data between the current aerial view and the reference aerial view.

In another aspect of the present disclosure, a dust detection system for a worksite is disclosed. The dust detection system includes at least one aircraft equipped with a perception sensor, a position detector and a controller. The controller is communicably coupled to the at least one aircraft. The controller is configured to generate a reference aerial view of at least a portion of the worksite during a no-dust condition of the worksite. The controller also generates a current aerial view of at least the portion of the worksite. The controller further determines presence of dust at the portion of the worksite on finding a difference in visual data between the current aerial view and the reference aerial view.

### BRIEF DESCRIPTION OF THE DRAWINGS

FIG. 1 illustrates a top view of a worksite in a no-dust condition.

FIG. 2 illustrates a top view of the worksite in accordance with an embodiment of present disclosure.

FIG. 3 illustrates a method for dust detection at the worksite.

### DETAILED DESCRIPTION

Reference will now be made in detail to the embodiments of the invention, examples of which are illustrated in the accompanying drawings. Wherever possible, the same reference number will be used throughout the drawings to refer to the same or like parts.

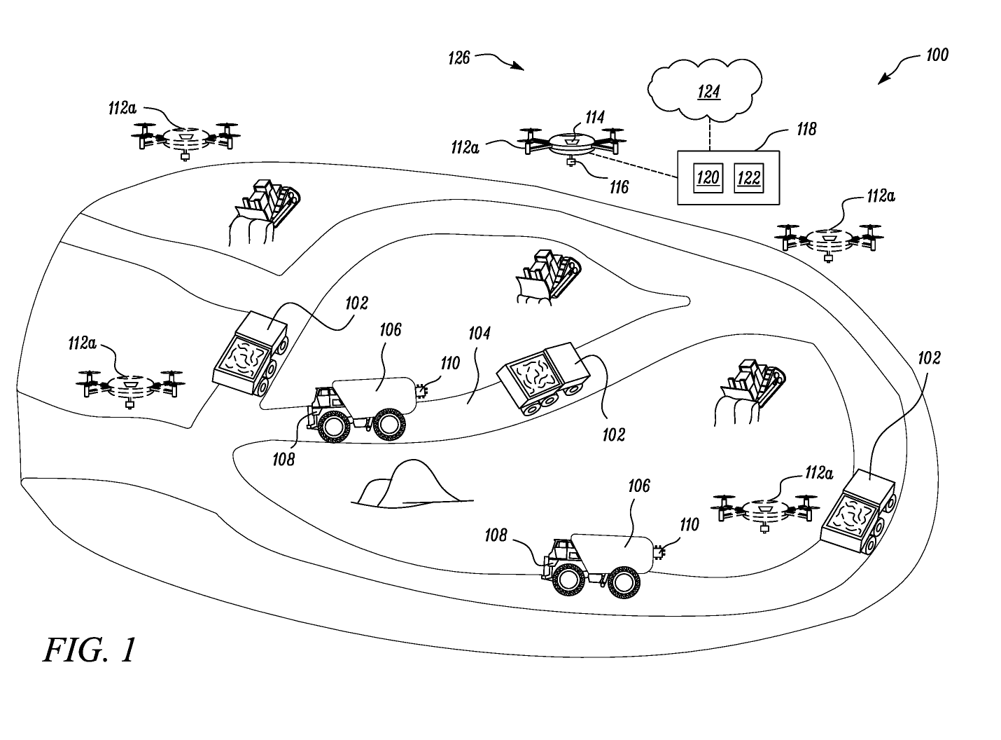

FIG. 1 illustrates an exemplary worksite 100. The worksite 100 may be a surface mining site, a construction site, a landfill, or any other site where various operations generate dust. The presence of dust at the worksite 100 may make it cumbersome for the operator to carry out various operations.

As shown in FIG. 1, a plurality of machines 102 may operate on the worksite 100. The machine 102 may be an operator-controlled machine, autonomous machines, or semi-autonomous machines. The machines 102 may include mining machines, off-highway haul trucks, articulated trucks, excavators, loaders, dozers, scrapers, or other types of earth-working machines for performing various operations at the worksite 100. In an embodiment the machine 102 may be a transportation machines, transporting the excavated material to another location, which may increase the dust level at the worksite 100. The machine 102 may include a work implement. The work implement may be any tool used in the performance of a work-related task. For example, work implement may include one or more of a blade, a shovel, a ripper, a dump bed, a fork arrangement, a broom, a grasping device, a cutting tool, a digging tool, a propelling tool, a bucket, a loader or any other tool known in the art.

In connection with various work operations, the machines 102 may travel along haul roads 104 between excavation locations, dumping areas, and other locations on worksite 100. One or more of the haul roads 104 may be sloped, and one or more of the haul roads 104 may act as an entrance ramp into the worksite 100 and an exit ramp out of worksite 100. Aside from the machines 102, one or more fluid delivery machines 106 (generally referred to as fluid delivery trucks or fluid trucks) may travel on worksite 100. In particular, the fluid delivery machine 106 may travel at the worksite 100 along haul roads 104 and to deliver fluid (e.g., spray fluid) onto the ground surface of worksite 100 to control dust levels.

The fluid delivery machine 106 may be an off-highway truck converted for use to deliver fluid. The fluid delivery machine 106 includes an engine (not shown), for example, an internal combustion engine or any other power source, which may be supported on a frame 108 of the fluid delivery machine 106. The fluid delivery machine 106 may be fitted with, among other things, a fluid tank configured to store fluid (e.g., water), various piping, hoses, pumps, valves, and one or more spray heads 110 that are configured to spray the fluid stored in the fluid tank onto the ground surface of worksite 100.

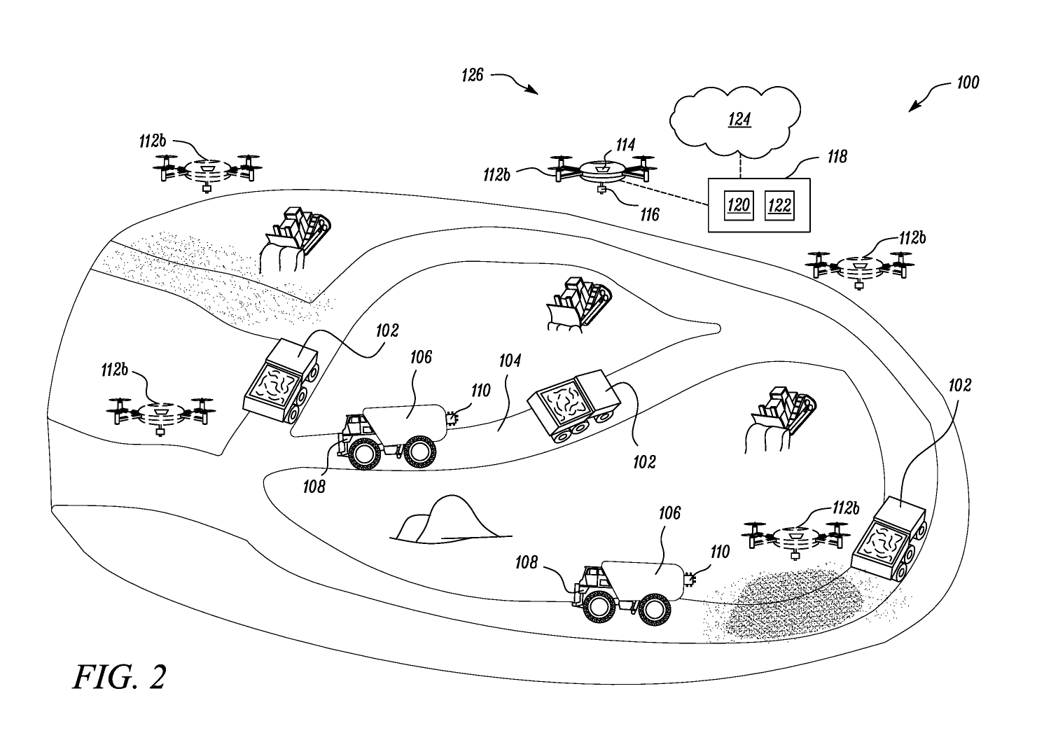

Referring to FIG. 1 and FIG. 2, the worksite 100 is deployed with a dust detection system 126. The dust detection system 126 includes a first craft 112a, a second aircraft 112b, a controller 118 and a central server 124. Although, the first aircraft 112a and the second aircraft 112b are contemplated, a single aircraft or more than two aircrafts may be included in the dust detection system 126. The first aircraft 112a and the second aircraft 112b may be configured to patrol above the worksite 100. In an embodiment, the first aircraft 112a and the second aircraft 112b may be an unmanned aerial vehicle (UAV). In an alternate embodiment, the first aircraft 112a and the second aircraft 112b may be a satellite. In various another embodiments, the first aircraft 112a and the second aircraft 112b may be any vehicle capable of capturing vision data from a point above the worksite 100. The first aircraft 112a and the second aircraft 112b may be launched from a base station. In an embodiment, the base station is located at the worksite 100. In an alternate embodiment, the base station may be located at a remote location. Both the first aircraft 112a and the second aircraft 112b include a perception sensor 114 and a position detector 116. The perception sensor 114 may include any device that is capable of providing the vision data describing an environment of the worksite 100.

The perception sensor 114 may be mounted on the first aircraft 112a and the second aircraft 112b. The perception sensor 114 may be any device that may monitor and generate images of the worksite 100. For example, the perception sensor 114 may be a LIDAR (light detection and ranging) device, a RADAR (radio detection and ranging) device, a stereo camera, a monocular camera, or another device known in the art. In an embodiment, the perception sensor 114 may include an emitter that emits a detection beam. Further, the perception sensor 114 also includes a receiver that may receive a reflection of the detection beam. The detection beam may be reflected by a physical object. The perception sensor 114 receives the beam reflected by the physical object and determines the distance and the direction of the physical object from the perception sensor 114. By utilizing beams from plurality of directions, the perception sensor 114 may generate an image of the surroundings of the worksite 100. In an alternate embodiment, the perception sensor 114 may also transmit the distance and direction of the physical object to the controller 118. In an embodiment, the perception sensor 114 may generate a 3D point cloud representation of the worksite 100 describing the environment at the worksite 100 or at least a portion of the worksite 100. In another embodiment, the perception sensor 114 may generate 2D images of the worksite 100 or at least the portion of the worksite 100. Further, the coordinates of the first aircraft 112s and second aircraft 112b may also be determined using the position detector 116.

The position detector 116 may be configured to provide location of the first aircraft 112a and the second aircraft 112b or any of its other associated component. The position detector 116 may be any one or a combination of a Global Positioning System (GPS), a Global Navigation Satellite System, a Pseudolite/Pseudo-Satellite, any other Satellite Navigation System, an Inertial Navigation System or any other known position detection system known in the art. In illustration of the present embodiment, the position detector 116 may receive or determine the positional information associated with the perception sensor 114. The positional information from the position detector 116 may be directed to the controller 118 for further processing.

The controller 118 may be communicably coupled with the first aircraft 112a, the second aircraft 112b, the perception sensor 114 and the position detector 116. The controller 118 may be a microprocessor or any other electronic device to control a plurality of devices. In an embodiment, the controller 118 may be an electronic control module (ECM). The controller 118 may be configured to receive signals from various electronic devices, but not limited to, the first aircraft 112a, the second aircraft 112b, the perception sensor 114 and the position detector 116. In an alternate embodiment, the controller 118 may also be configured to transmit signals to various electronic devices, but not limited to, the first aircraft 112a, the second aircraft 112b, the perception sensor 114 and the position detector 116. In the embodiment illustrated, the controller 118 may be located on the machine 102. In alternate embodiment, the controller 118 may be located at a remote location. The controller 118 may include a memory unit 120 and a processing unit 122.

The memory unit 120 may include one or more storage devices configured to store information used by the controller 118 to perform certain functions related to the present invention. The processing unit 122 may include one or more known processing devices, such as a microprocessor or any other device known in the art. In the embodiment illustrated, the memory unit 120 and processing unit 122 may be included together in a single unit. In an alternate embodiment, the memory unit 120 and processing unit 122 may be incorporated separately.

The controller 118 is configured to control movement and operation of the first aircraft 112a and the second aircraft 112b. In the present embodiment, the controller 118 may launch the first aircraft 112a and the second aircraft 112b from the base station. In an alternate embodiment, the controller 118 may also be configured to return the first aircraft 112a and the second aircraft 112b back to the base station. The first aircraft 112a and the second aircraft 112b may be maneuvered along a path via predefined waypoints. In an embodiment, the waypoints may be the coordinates of the worksite where loading, dumping or other operations are done on a regular basis. In an alternate embodiment, waypoints may be the path enclosing at least a portion of the worksite 100 where operations may be taking place. In yet another embodiment, the waypoints may be a path around the worksite 100, from where a view of worksite 100 can be obtained. The waypoints may be fed to the first aircraft 112a and the second aircraft 112b by the operator via controller 118. In an alternate embodiment, the controller 118 may have a work schedule of one or more machines 102 operating at the worksite 100 stored in its memory unit 120. The controller 118 may define the waypoints to be followed by the first aircraft 112a and the second aircraft 112b according to the work schedule of machines 102 operating at the worksite 100.

The controller 118 may receive the vision data from the perception sensor 114 disposed on the first aircraft 112a. The controller 118 further receives the coordinates of the first aircraft 112a from the position detector 116. In an alternate embodiment, the vision data the perception sensor 114 disposed on the first aircraft 112b. The controller 118 further receives the coordinates of the first aircraft 112b from the position detector 116. The controller 118 utilizes information from the position detector 116 and perception sensor 114 to formulate the coordinates of the 2D images or 3D point cloud representation of the worksite 100 or at least the portion of the worksite 100. The processing unit 122 generates a geo-referenced aerial view, also referred as reference aerial view of at least a portion of the worksite 100 in a no-dust condition. The no-dust condition is a condition when the dust at the worksite 100 is completely settled. The no-dust condition may be obtained just after spraying the worksite 100 with a fluid via the fluid delivery system 106. In an alternate embodiment, the reference aerial view may be generated when no operations are carried out at the worksite 100 for an extended period of time. In yet another embodiment, the reference aerial view also may be generated when dust exists on the worksite 100. The reference aerial view may be stored in the memory unit 120. In an embodiment, the reference aerial view may be generated periodically. In the embodiment illustrated, the reference aerial view may be a 3D representation of at least a portion of the worksite 100. In an alternate embodiment, the reference aerial view may be a 3D terrain map of at least a portion of the worksite 100. In another embodiment, the reference aerial view may be a 2D image of the worksite 100 or at least a portion of the worksite 100.

The controller 118 may further receive the vision data of the worksite 100 from the perception sensor 114 of second aircraft 112b. In an alternate embodiment, controller 118 may receive the vision data of the worksite 100 from the perception sensor 114 of the first aircraft 112a. Similarly, another geo-referenced view, also referred as a current aerial view, of at least a portion of the worksite 100 is generated by the processing unit 122, as shown in FIG. 2. In the embodiment illustrated, the current aerial view may be a 3D representation of the worksite 100. In an alternate embodiment, the current aerial view may be a 3D terrain map. In yet another embodiment, the current aerial view may be a 2D image of at least a portion of the worksite 100. Further, the current aerial view may be generated periodically. In an alternate embodiment, the current aerial view may be generated when the operator needs to determine the dust level at the worksite 100. In an alternate embodiment, plurality of second aircrafts 112b are configured to patrol above the worksite 100. The controller 118 may control the plurality of second aircrafts 112b to generate the image feed of the entire worksite 100. In another various embodiments, plurality of second aircrafts 112b may be deployed at the worksite 100 to continuously monitor the worksite 100 or at least the portion of the worksite 100. For example, when battery of the second aircraft 112b is low, it is returned to a base station and simultaneously another second aircraft 112b may take the position of the previous second aircraft 112b.

After generation of the reference aerial view and the current aerial view, the controller 118 compares the reference aerial view and the current aerial view. The comparison is done to determine presence of dust at the worksite 100 which may be on the basis of difference in vision data between the reference aerial view and the current aerial view. When the current aerial view completely matches the reference aerial view, it indicates negligible dust level at the worksite 100. One may also contemplate that when there is variation in the reference aerial view and current aerial view, the controller 118 may determine that there is dust at the worksite 100. In an alternate embodiment, the controller 118 may be communicably coupled to a display unit (not shown). The display unit may be located at a remote location or central location or on the machine 102. The controller 118 may direct the reference aerial view and the current aerial view to the display unit.

By comparing the reference aerial view and the current aerial view, controller 118 may determine the variations between the two views. For example, if the surface of the worksite 100 is not similar in current aerial view as compared to the reference aerial view, this means that there may be dust at that portion of the worksite 100. For example, if the ground surface if partially visible in the current aerial view as compared to the reference aerial view, then the dust level may be moderate. One may also contemplate that when the dust level is very high, the density of the dust at the portion of the worksite 100 is very high. The perception sensors 114 may not be able to see through the dust and may not be able to acquire the vision data of that particular portion of the worksite 100. In an embodiment, the operator may set a threshold level according to the nature of operations being carried out at the worksite 100. The memory unit 120 may store an algorithm configured to calculate the dust level at the worksite by determining the variation in the reference aerial view and current aerial view. For example, after comparing the current aerial view with the reference aerial view, a 20% mismatch in visibility may be determined by the algorithm. This may indicate a 20% dust level at the worksite 100. In this case, the current aerial view of the worksite 100 or at least the portion of the worksite 100 may be hazy. According to the nature of the operation, operator may set the threshold level at 50%. Therefore, controller 118 may determine when the presence of dust exceeds the threshold level and perform further operations. In case of extreme dust, the dust level may be 100% and the current aerial view of the worksite 100 or at least the portion of the worksite 100 may show a dark spot. In yet another embodiment, the threshold level may be different for different worksites.

In another embodiment, the dust level may be determined by calculating the noise level using the perception sensor 114 (LIDAR, SONAR) at the particular portion of the worksite 100. If the noise level is high then the density of the dust at the worksite 100 may be high. On the other hand, if the noise level is low, then the density of the dust at the worksite 100 may be low. In yet another embodiment, the process of dust detection may be done on a periodic basis i.e. current aerial view is generated and compared with reference aerial view on a periodic basis. When the dust level exceeds the threshold level, the controller 118 transmits the location coordinates of the area, where dust density is high, to a central server 124.

The central server 124, after receiving the location coordinates of the portion of the worksite 100 having high dust level from the controller 118, may initiate a preventive action if the dust level exceeds the threshold level. The preventive action may include dust control measures such as, informing the fluid delivery machines 106 about the dust level at various areas of the worksite 100. The preventive actions may further include transmitting a warning signal to the machines 102 working nearby the area having high dust level. To control the dust level, the position coordinates and the density of the dust in an area may be transmitted to the fluid delivery machines 106. In an alternate embodiment, the controller 118 may also transmit the dust level along with the location coordinates of area with high density of dust to a worksite management team. The controller 118 may also transmit a warning signal to one or more machines 102 operating at the worksite if dust levels exceed a predefined threshold. The worksite management team may further initiate the preventive actions to reduce the dust level. In another embodiment, the controller 118 may itself initiate the preventive actions for dust control.

After the preventive measures are carried out at the worksite 100, another current aerial view of at least the portion of the worksite 100 is generated. The current aerial view is again compared with the reference aerial view on the basis of visibility. In an embodiment, if the current aerial view and the reference aerial view matches well, then controller 118 may return the first aircraft 112a or the second aircraft 112b back to the base station. In another embodiment, the controller 118 may modify the waypoints for the navigation of the first aircraft 112a and the second aircraft 112b to detect the dust conditions at other locations on the worksite 100.

Thus, dust level at the worksite 100 may be determined by comparing the reference aerial view and the current aerial view and further commands may be given to the fluid delivery machines 106 to control the dust at the worksite 100 or at least a portion of the worksite 100.

### INDUSTRIAL APPLICABILITY

Worksites associated with mining, excavation, construction, landfills, and material stockpiles may be susceptible to dust due to the nature of the materials composing the worksite surface. In addition, heavy machinery, such as haul trucks, dozers, loaders, excavators, etc., traveling on such sites may disturb settled dust, thereby increasing the dust level in the air. Undue dust conditions may reduce the efficiency a worksite. For example, dust may impair visibility, interfere with work operations on the site, and require increased equipment maintenance and cleaning. In addition, undue dust conditions may compromise the comfort, health, and safety of worksite personnel. With the introduction of semi/fully autonomous operations at worksites, operator may not be able to clearly visualize the movement of the machines 102 or work tool of the machines 102.

In an aspect of the present disclosure, a dust detection system 126 including a first aircraft 112a, a second aircraft 112b and a controller 118 is configured to automatically determine the presence of dust at the worksite 100. The dust detection system 126 may also determine the dust level at the worksite 100. The dust detection system 126 may determine the dust level periodically. Thus, the operator may not have to determine the presence of the dust at the worksite 100 while operating autonomous or semi-autonomous machines. The controller 118 of the dust detection system 126 may even instruct the plurality of machines 102 to slow down or in some cases halt the machine 102 to avoid any mishap.

In another aspect of the present embodiment, the dust detection system 126 may warn a plurality of machines 102 working on the same worksite about the presence of the dust. The dust detection system 126 may also raise an alarm when the dust level exceeds the threshold level. In yet another aspect of the present embodiment, the dust detection system 126 may also initiate preventive measures. The dust detection system 126 may transmit the location of the dusty area i.e. portion of worksite 100 with high dust level to the fluid delivery machines 106. The fluid delivery machines 106 spray the fluid via spray heads 110 at the worksite 100 or at least the portion of the worksite 100 to control the dust level. In an alternate embodiment, the dust detection system 126 may also transmit the dust level to the fluid delivery machines 106, so that adequate amount of fluid is sprayed over the area where high dust level is observed.

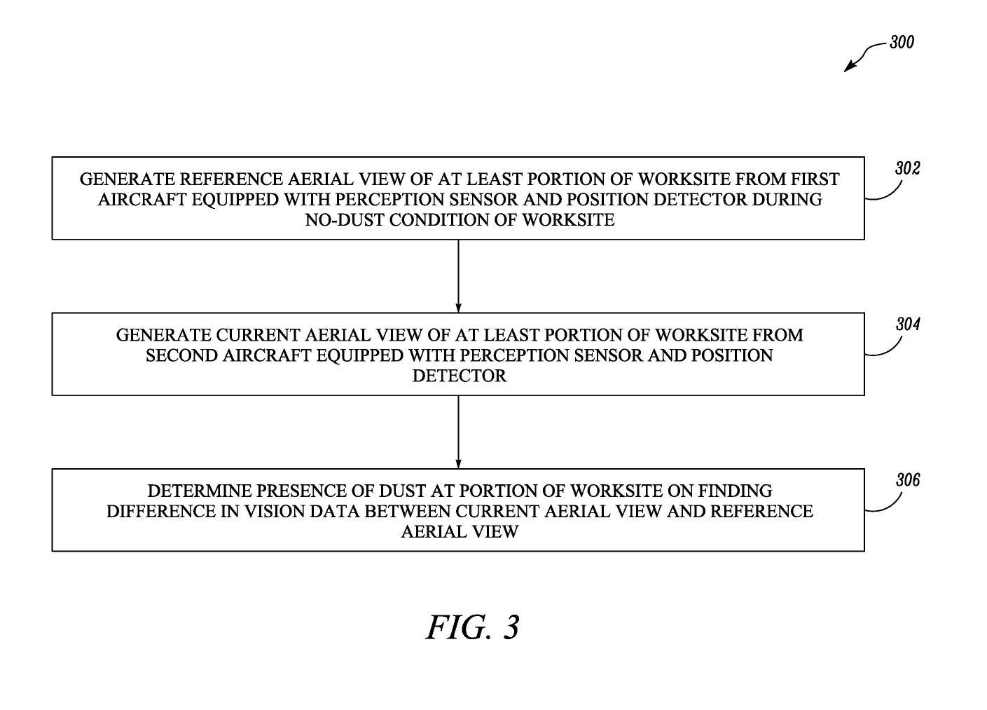

Further, the present disclosure provides a method 300 for detecting dust at the worksite 100 with reference to FIG. 3. The controller 118 further generates a geo-referenced aerial view, referred as reference aerial view of the worksite 100 or at least a portion of the worksite 100 from a first aircraft 112a equipped with a perception sensor 114 and a position detector 116 in a no-dust condition (step 302).

The controller 118 receives the vision data the perception sensor 114. The controller 118 formulates the location coordinates of the vision data by processing the information from the position detector 116 and the perception sensor 114. The method 300 further includes a step in which controller 118 generates another geo-referenced aerial view, referred as current aerial view, of the worksite 100 or at least a portion of the worksite 100 from a second aircraft 112b equipped with a perception sensor 114 and a position detector 116 (step 304). After generating the current aerial view of the worksite 100, controller 118 determines presence of dust at the portion of the worksite on finding a difference in vision data between the current aerial view and the reference aerial view (step 306).

While aspects of the present disclosure have seen particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method of detecting dust at a worksite, the method comprising:
generating a reference aerial view of at least a portion of the worksite from a first aircraft equipped with a perception sensor and a position detector during a no-dust condition of the worksite;
generating a current aerial view of at least the portion of the worksite from a second aircraft equipped with a perception sensor and a position detector; and
determining presence of dust at the portion of the worksite on finding a difference in vision data between the current aerial view and the reference aerial view.

2. The method of claim 1, wherein the first aircraft and the second aircraft is an unmanned aerial vehicle.

3. The method of claim 1, wherein the current aerial view and the reference aerial view are generated from the first aircraft or the second aircraft.

4. The method of claim 1, further comprising predefining waypoints for navigation of the first aircraft and the second aircraft.

5. The method of claim 1, further comprising determining waypoints for navigation of the first aircraft and the second aircraft based on the work schedule of one or more machines operating at the worksite.

6. The method of claim 1, further comprising generating a geo-referenced aerial view of the worksite from the data received from the perception sensor and the position detector.

7. The method of claim 1, wherein the reference aerial view and the current aerial view is a 3D terrain map.

8. The method of claim 1, further comprising periodically generating the current aerial view and comparing the current aerial view with the reference aerial view.

9. The method of claim 1, further comprising initiating dust control measures if dust levels exceed a predefined threshold.

10. The method of claim 1, further comprising transmitting warning signal to one or more machines operating at the worksite if dust levels exceed a predefined threshold.

11. A dust detection system for a worksite comprising:
at least one aircraft including a perception sensor and a position detector; and
a controller communicably coupled to the at least one aircraft, the controller configured to:
generate a reference aerial view of at least a portion of the worksite during a no-dust condition of the worksite;
generate a current aerial view of at least the portion of the worksite from the at least one aircraft; and
determine presence of dust at the portion of the worksite on finding a difference in vision data between the current aerial view and the reference aerial view.

12. The dust detection system of claim 11, wherein the aircraft is an unmanned aerial vehicle.

13. The dust detection system of claim 11, wherein the controller is configured to predefine waypoints for navigation of the aircraft.

14. The dust detection system of claim 11, wherein the controller is configured to determine waypoints for navigation of the aircraft based on a work schedule of one or more machines operating at the worksite.

15. The dust detection system of claim 11, wherein the controller generates a geo-referenced aerial view of the worksite from the data received from the perception sensor and the position detector.

16. The dust detection system of claim 11, wherein the reference aerial view and the current aerial view is a 3D terrain map.

17. The dust detection system of claim 11, wherein the controller periodically generates the current aerial view and compares the current aerial view with the reference aerial view.

18. The dust detection system of claim 11, further comprising a central server in communication with the controller, the central server configured to initiate dust control measures if dust levels exceed a predefined threshold.

19. The dust detection system of claim 11, wherein the controller transmits a warning signal to one or more machines operating at the worksite if dust levels exceed a predefined threshold.

20. The dust detection system of claim 11, wherein the position detector is a global positioning system.
